(19) United States
(12) Patent Application Publication
(10) Pub. No.: US 2011/0221286 A1
(43) Pub. Date: Sep. 15, 2011

(54) ELECTRIC ROTATING MACHINE

(75) Inventors: Kazunori Uchiyama, Okazaki-shi (JP); Naoki Hakamada, Anjo-shi (JP); Masahiro Seguchi, Obu-shi (JP)

(73) Assignees: NIPPON SOKEN, INC., Nishio-city (JP); DENSO CORPORATION, Kariya-city (JP)

(21) Appl. No.: 13/045,889

(22) Filed: Mar. 11, 2011

(30) Foreign Application Priority Data
Mar. 12, 2010 (JP) 2010-055468

(51) Int. Cl. H02K 9/19

(52) U.S. Cl. 310/54

(57) ABSTRACT

An electric rotating machine includes a stator, a rotor, and a housing. The stator includes a stator core and a stator coil formed by laminating magnetic steel sheets. Each of the magnetic steel sheets has through-holes that are formed to penetrate the magnetic steel sheet in the axial direction of the stator core. All of the magnetic steel sheets are divided into groups each of which includes axially-adjacent n of the magnetic steel sheets, where n is an integer not less than 2. For each of the groups, corresponding n of the through-holes of the n magnetic steel sheets of the group communicate with one other to form an inside coolant passage. The inside coolant passage fluidically connects an outside coolant passage, which is formed between the housing and the radially outer surface of the stator core, with a corresponding one of the slots of the stator core.

### CROSS-REFERENCE TO RELATED APPLICATION

This application is based on and claims priority from Japanese Patent Application No. 2010-55468, filed on Mar. 12, 2010, the content of which is hereby incorporated by reference in its entirety into this application.

### BACKGROUND

1. Technical Field

The present invention relates to electric rotating machines that are used in, for example, motor vehicles as electric motors and electric generators.

2. Description of the Related Art

Conventionally, electric rotating machines, which are used in, for example, motor vehicles as electric motors and electric generators, generally include a stator and a rotor. The stator includes a hollow cylindrical stator core, a stator coil, and an insulator. The stator core is formed by laminating a plurality of magnetic steel sheets and has a plurality of slots that are formed in the radially inner surface of the stator core and spaced in the circumferential direction of the stator core. The stator coil is mounted on the stator core so as to be partially received in the slots of the stator core. The insulator is interposed between the stator core and the stator coil so as to electrically insulate them from each other. The rotor is rotatably disposed radially inside the stator core.

Moreover, in a liquid-cooled electric rotating machine, the heat generated by the stator coil during operation is generally dissipated by using a liquid coolant. For example, cooling oil is supplied to drop on coil ends of the stator coil; the coil ends protrude outside the slots of the stator core respectively on opposite axial sides of the stator core. Then, the cooling oil spreads along the surfaces of the coil ends, flowing into gaps between the insulator and the stator core and between the insulator and the stator coil. Consequently, the heat resistance between the stator coil and the stator core is lowered, thereby allowing the heat generated by the stator coil to be effectively transmitted to the stator core.

However, due to manufacturing tolerances, the stator core may have uneven internal walls which define the slots of the stator core. In this case, if the insulator is disposed in partial contact with the internal walls of stator core, it will be difficult for the cooling oil to spread over the entire axial length of each of the gaps between the insulator and the stator core. Consequently, air will remain in the gaps between the insulator and the stator core, thereby keeping high the heat resistance between the stator coil and the stator core. As a result, it will be difficult for the heat generated by the stator coil to be effectively transmitted to the stator core.

To solve the above problem, Japanese Patent Application Publication No. 2005-12989 (to be referred to as Patent Document 1 hereinafter) discloses a first technique. According to the first technique, a plurality of cooling oil passages are formed in the stator core. Each of the cooling oil passages extends in a radial direction of the stator core so as to fluidically connect one of the slots of the stator core to the radially outside of the stator core. Consequently, the cooling oil can be supplied from the radially outside of the stator core into the slots of the stator core via the cooling oil passages (see, paragraph [0042] and FIGS. 2-6 of Patent Document 1).

However, with the first technique disclosed in Patent Document 1, at least part of the magnetic steel sheets forming the stator core are made, by the corresponding cooling oil passages, to be discontinuous in the circumferential direction of the stator core. Consequently, the strength of each of the discontinuous magnetic steel sheets and thus the strength of the entire stator core may be considerably lowered.

Moreover, Patent Document 1 also discloses a second technique for solving the above-described problem. According to the second technique, all of the magnetic steel sheets forming the stator core are divided into a plurality of groups each of which includes a predetermined number of the magnetic steel sheets.

Moreover, between each adjacent pair of the groups, there is welded a spacer to form a gap therebetween. Consequently, via the gaps formed between the adjacent groups of the magnetic steel sheets, the slots of the stator core become fluidically connected to the radially outside of the stator core. As a result, the cooling oil can be supplied from the radially outside of the stator core into the slots of the stator core via the gaps (see, paragraphs [0061]-[0062] and FIG. 8 of Patent Document 1).

However, with the second technique disclosed in Patent Document 1, it is necessary to prepare and weld the spacers for forming the gaps. Consequently, the manufacturing cost will be increased. In addition, the magnetic steel sheets may be deformed during the welding of the spacers.

Japanese Patent Application Publication No. 2000-50552 (to be referred to as Patent Document 2 hereinafter) discloses a third technique for solving the above-described problem. According to the third technique, silicone is first applied on the insulator (or insulating sheets). Then, the insulator having the silicone applied thereon is inserted into the slots of the stator core. Consequently, the gaps between the insulator and the stator core are filled with the silicone. As a result, the heat resistance between the stator coil and the stator core is lowered, thereby allowing the heat generated by the stator coil to be effectively transmitted to the stator core.

However, with the third technique disclosed in Patent Document 2, for completely filling the gaps between the insulator and the stator core with the silicone, it is necessary to evenly apply the silicone on the insulator by, for example, vacuum impregnation. Consequently, the manufacturing cost will be increased.

### SUMMARY

According to an embodiment, there is provided an electric rotating machine which includes a stator, a rotor, and a housing. The stator includes a hollow cylindrical stator core and a stator coil mounted on the stator core. The stator core is formed by laminating a plurality of magnetic steel sheets and has a plurality of slots that are formed in the radially inner surface of the stator core and spaced in the circumferential direction of the stator core. The stator coil is partially received in the slots of the stator core to have a pair of coil ends that protrude outside the slots of the stator core respectively on opposite axial sides of the stator core. The rotor is rotatably disposed radially inside the stator core. The housing receives both the rotor and the stator with a gap formed between the inner surface of the housing and the radially outer surface of the stator core; the gap makes up an outside coolant passage in which a coolant is to flow. Furthermore, each of the magnetic steel sheets forming the stator core has a plurality of through-holes that are formed to penetrate the magnetic steel sheet in the axial direction of the stator core. All of the magnetic steel sheets forming the stator core are divided into a plurality of groups each of which includes axially-adjacent n of the magnetic steel sheets, where n is an integer not less than 2. For each of the groups, corresponding a of the through-holes of the n magnetic steel sheets of the group communicate with one other to form an inside coolant passage that fluidically connects the outside coolant passage with a corresponding one of the slots of the stator core.

With the above configuration, the coolant can flow from the outside coolant passage into each of the slots of the stator core via the corresponding inside coolant passages. Consequently, the heat resistance between the stator core and the stator coil can be reduced, thereby more effectively transmitting the heat generated by the stator coil to the stator core. As a result, it is possible to suppress the increase in the resistance of the stator coil due to the heat generated by the stator coil, thereby ensuring high efficiency of the electric rotating machine. Moreover, it is also possible to prevent the insulating coat of the stator coil from being damaged by the heat generated by the stator coil. Furthermore, since the inside coolant passages are formed without making the magnetic steel sheets discontinuous in the circumferential direction, it is possible to ensure the strength of each of the magnetic steel sheets and thus the strength of the entire stator core.

According to another embodiment, there is provided an electric rotating machine which includes a stator, a rotor, and supplying means. The stator includes a hollow cylindrical stator core and a stator coil mounted on the stator core. The stator core is formed by laminating a plurality of magnetic steel sheets and having a plurality of slots that are formed in the radially inner surface of the stator core and spaced in the circumferential direction of the stator core. The stator coil is partially received in the slots of the stator core to have a pair of coil ends that protrude outside the slots of the stator core respectively on opposite axial sides of the stator core. The rotor is rotatably disposed radially inside the stator core. The supplying means supplies a coolant to the coil ends of the stator coil. Furthermore, in those internal walls of the magnetic steel sheets which define the slots of the stator core, there are formed grooves that extend in the axial direction of the stator core.

With the above configuration, if an insulator is interposed between the stator coil and the stator core in partial contact with the internal walls of the magnetic steel sheets, it is possible for the coolant to flow through the grooves to occupy the entire axial length of each of the gaps between the insulator and the internal walls of the magnetic steel sheets. As a result, the heat resistance between the stator core and the stator coil can be reduced, thereby more effectively transmitting the heat generated by the stator coil to the stator core.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a schematic cross-sectional view illustrating the overall configuration of an electric rotating machine according to the first embodiment of the invention;

FIG. 2 is a cross-sectional view taken along the line II-II in FIG. 1;

FIG. 3 is a cross-sectional view taken along the line in FIG. 2;

FIG. 4 is a cross-sectional view illustrating the formation of through-holes in an A magnetic steel sheet included in a stator core of the electric rotating machine;

FIG. 5 is a cross-sectional view illustrating the formation of through-holes in a B magnetic steel sheet included in the stator core;

FIG. 6 is a cross-sectional view illustrating the formation of through-holes in an E magnetic steel sheet included in the stator core;

FIG. 7 is a schematic view illustrating a parameter θ in the first embodiment;

FIG. 8 is a graphical representation illustrating the manner of setting a parameter a in the first embodiment;

FIG. 9 is a graphical representation illustrating the manner of setting a parameter b in the first embodiment;

FIG. 10 is an enlarged axial end view showing part of a stator according to the second embodiment of the invention;

FIG. 11 is a perspective view illustrating the formation of grooves in those internal walls of magnetic steel sheets which define the slots of a stator core according to the second embodiment;

FIG. 12 is an enlarged cross-sectional view showing part of the stator according to the second embodiment;

FIGS. 13 and 14 are respectively axial end and perspective views of a stator core according to the first comparative example; and

FIG. 15 is an enlarged cross-sectional view showing part of a stator according to the second comparative example.

### DESCRIPTION OF PREFERRED EMBODIMENTS

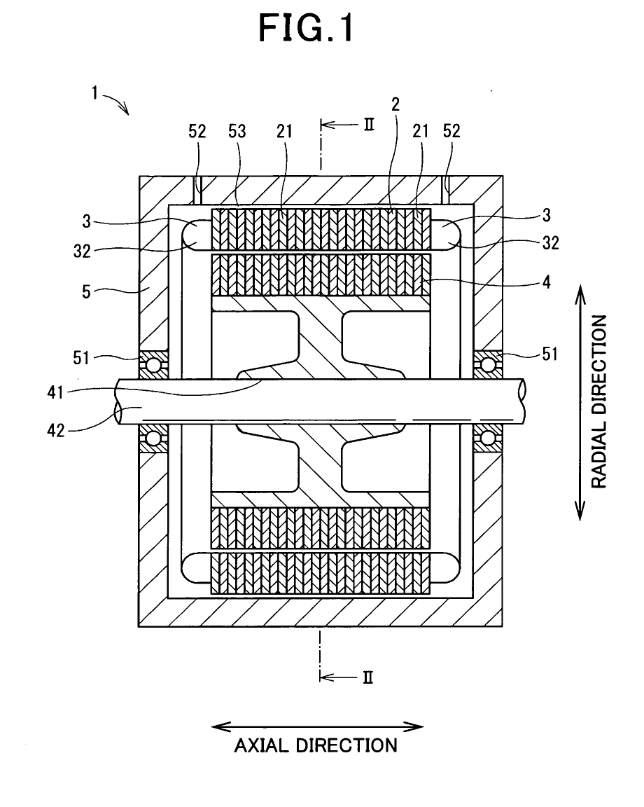

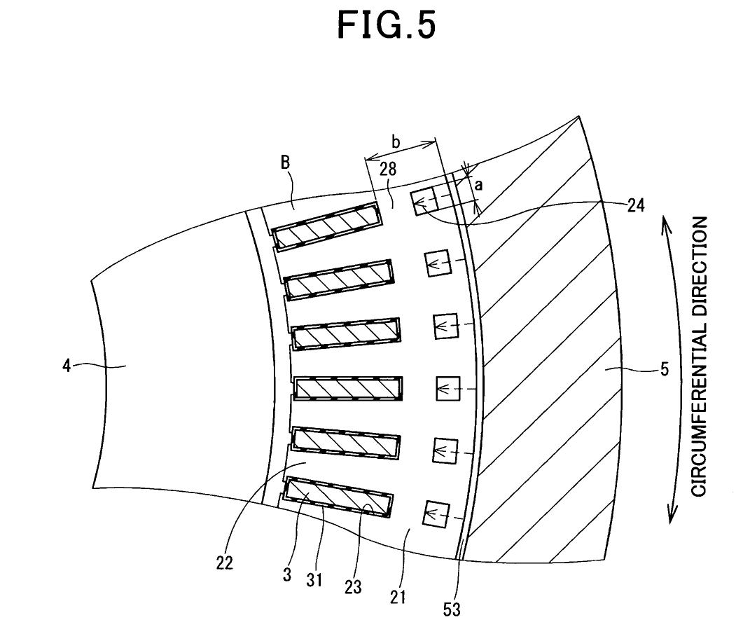

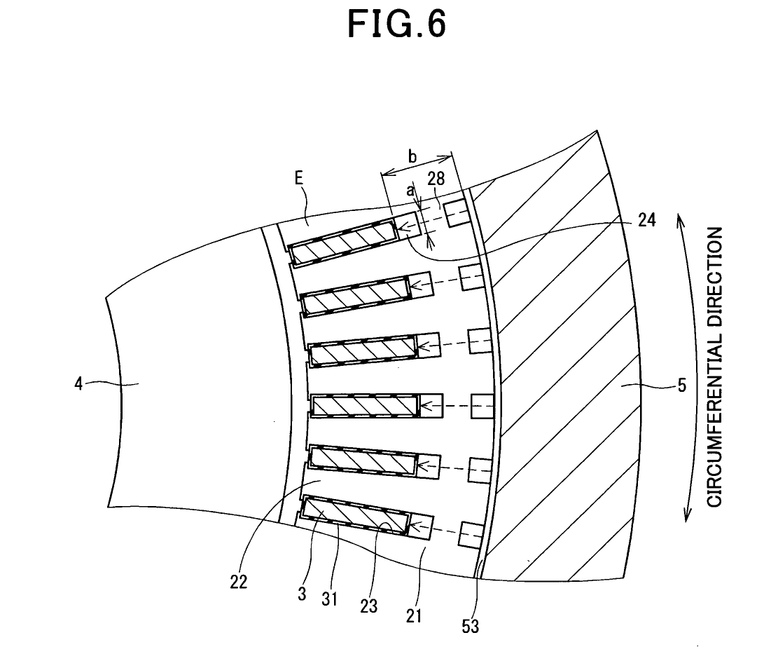

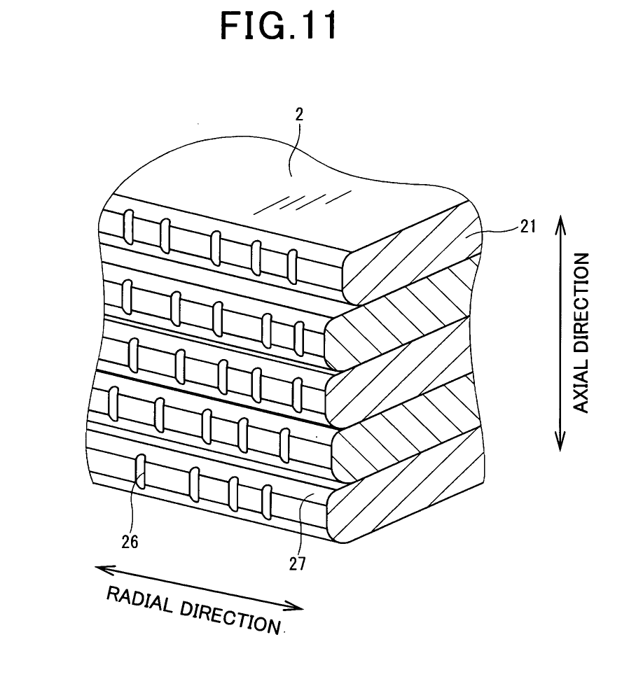

Preferred embodiments of the present invention will be described hereinafter with reference to FIGS. 1-15. It should be noted that for the sake of clarity and understanding, identical components having identical functions in different embodiments of the invention have been marked, where possible, with the same reference numerals in each of the figures and that for the sake of avoiding redundancy, descriptions of the identical components will not be repeated.

### [First Embodiment]

FIG. 1 shows the overall configuration of an electric rotating machine 1 according to the first embodiment of the invention.

In the present embodiment, the electric rotating machine 1 is configured as a brushless motor for use in, for example, a motor vehicle. As shown in FIG. 1, the electric rotating machine 1 includes a stator, a rotor 4, and a housing 5. The stator includes a stator core 2, a stator coil 3, and an insulator 31.

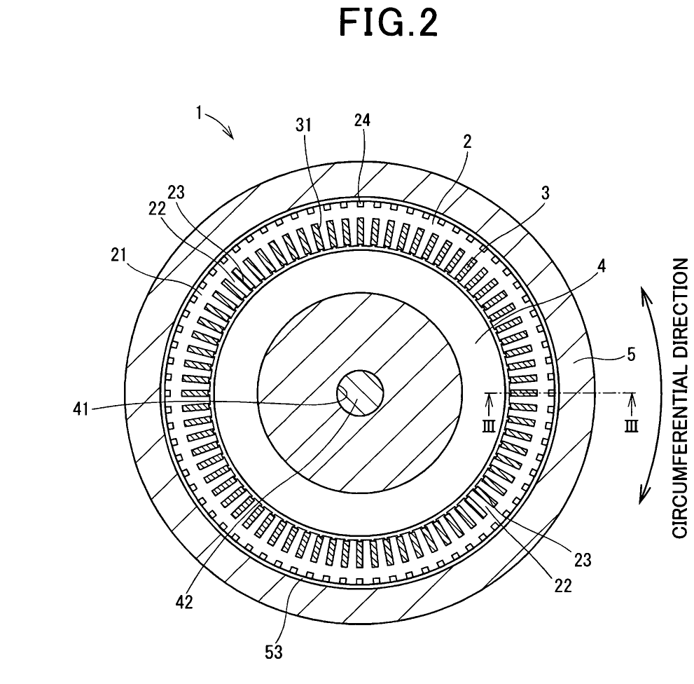

Referring to FIGS. 1 and 2, the stator core 2 is formed by laminating a plurality of magnetic steel sheets 21 and has a hollow cylindrical shape. The stator core 2 has a plurality of stator teeth 22 extending in the axial direction and a plurality of slots 23 each of which is formed between one circumferentially-adjacent pair of the stator teeth 22. More specifically, the slots 23 are formed in the radially inner surface of the stator core 2 and spaced by the stator teeth 22 in the circumferential direction of the stator core 2. In addition, the stator core 2 is fixed to the housing 5 by a not-shown fixing means.

The stator coil 3 is wound around each of the stator teeth 22 so as to be partially received in the slots 23 of the stator core 2. In addition, all of those portions of the stator coil 3 which protrude from the same axial end face of the stator core 2 together make up a coil end 32 of the stator coil 3. That is, the stator coil 3 includes two coil ends 32 that protrude outside the slots 23 of the stator core 2 respectively on opposite axial sides of the stator core 2.

The insulator 31 is interposed between the stator core 2 and the stator coil 3 so as to electrically insulate them from each other. More specifically, in each of the slots 23 of the stator core 2, the insulator 31 is interposed between the stator coil 3 and those internal walls of the stator core 2 which define the slot 23. In addition, the insulator 31 may be configured with insulating paper, insulating sheets or an electrically-insulative resin.

The rotor 4 is rotatably disposed radially inside the stator core 2. The rotor 4 includes a plurality of permanent magnets (not shown) that form a plurality of magnetic poles on the radially outer periphery of the rotor 4. The polarities of the magnetic poles alternate between north and south in the circumferential direction of the rotor 4 (or in the circumferential direction of the stator core 2). At the radial center of the rotor 4, there is formed a through-hole 41 in which a rotating shaft 42 is fixedly fitted. The rotating shaft 42 has an opposite pair of axial end portions that are supported by the housing 5 via a pair of bearings 51, respectively.

In operation, the stator creates a rotating magnetic field when electric current is supplied to the stator coil 3. The rotating magnetic field causes the rotor 4 to rotate together with the rotating shaft 42, thereby outputting torque through the rotating shaft 42.

The housing 5 has formed therein cooling oil inlets 52, through which a coolant is supplied from the outside to the inside of the housing 5. In the present embodiment, the coolant is implemented by cooling oil.

The cooling oil, which is introduced into the housing 5 through the cooling oil inlets 52, drops on the coil ends 32 of the stator coil 3. It should be noted that the cooling oil inlets 52 constitute means for supplying the cooling oil to the coil ends 32. In addition, it is assumed that the upward and downward directions in FIG. 1 respectively represent the vertically upward and downward directions.

Then, the cooling oil spreads along the surfaces of the coil ends 32 of the stator coil 3, flowing into the gaps between the magnetic steel sheets 21 (i.e., the stator core 2) and the insulator 31 and between the stator coil 3 and the insulator 31. In addition, the cooling oil also flows into an outside cooling oil passage 53 by means of capillary action; the outside cooling oil passage 53 is made up of the annular gap between the radially outer surface of the stator core 2 and the inner surface of the housing 5.

Each of the magnetic steel sheets 21 has a plurality of through-holes 24 that are formed to penetrate the magnetic steel sheet 21 in the thickness direction of the magnetic steel sheet 21 (or in the axial direction of the stator core 2) and are equally spaced in the circumferential direction of the stator core 2. Moreover, each of the through-holes 24 is radially aligned with a corresponding one of the slots 23 of the stator core 2.

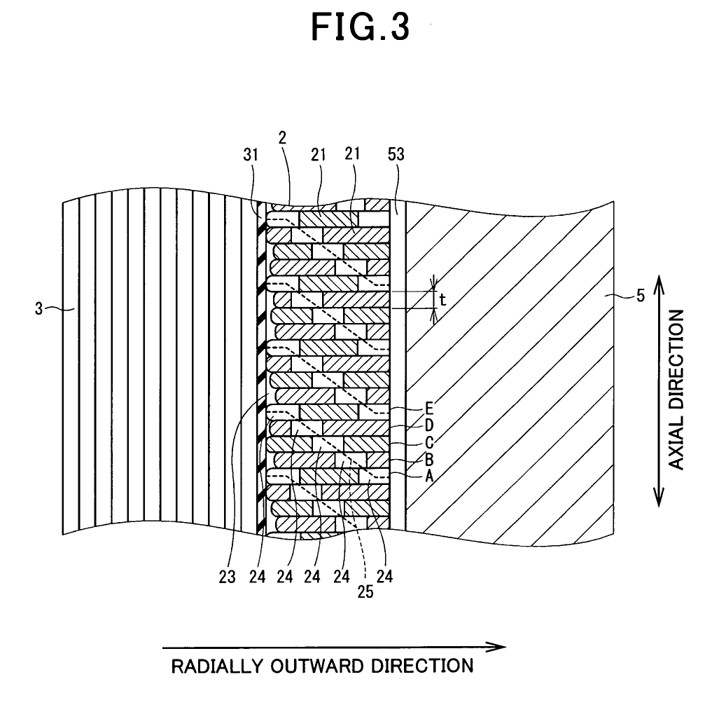

Referring further to FIG. 3, in the present embodiment, all of the magnetic steel sheets 21 forming the stator core 2 are divided into a plurality of groups each of which includes five axially-adjacent magnetic steel sheets 21 that are respectively denoted by A, B, C, D and E.

Moreover, as shown in FIGS. 3-6, for the A, B, C and D magnetic steel sheets 21, the radial positions of the through-holes 24 are different. The A magnetic steel sheet 21 is configured identical to the E magnetic steel sheet 21. Each of the A and E magnetic steel sheets 21 has first through-holes 24 each of which is formed to communicate with the outer cooling oil passage 53 and second through-holes 24 each of which is formed to communicate with the corresponding slot 23 of the stator core 2.

Furthermore, as shown in FIG. 3, for each group of the magnetic steel sheets 21, five corresponding through-holes 24 of the A, B, C, D and E magnetic steel sheets 21 communicate with one another in the axial direction of the stator core 2, forming an inside cooling oil passage 25. The inside cooling oil passage 25 fluidically connects the outside cooling oil passage 25 with a corresponding one of the slots 23 of the stator core 2. In addition, the inside cooling passage 25 is radially aligned with the corresponding slot 23.

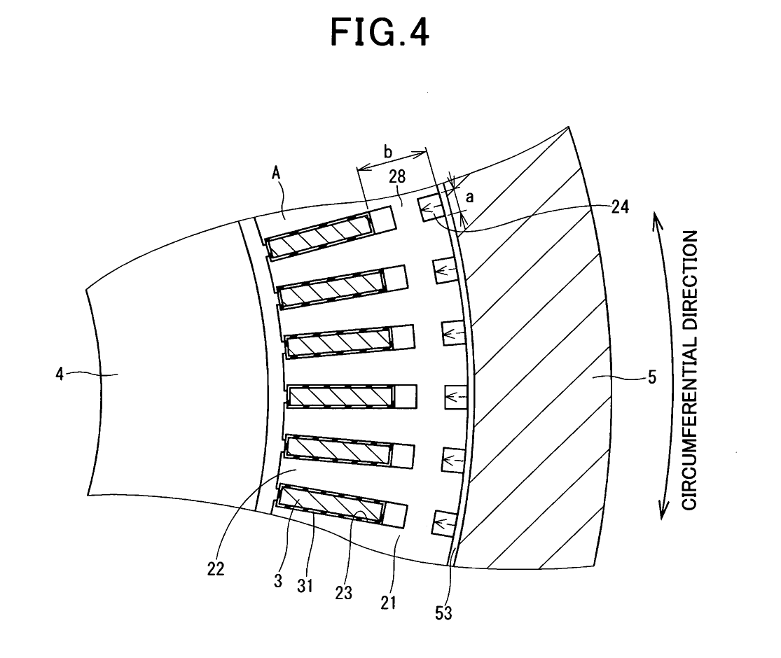

In operation, referring to FIGS. 3-6, for each of the inside cooling oil passages 25, the cooling oil first flows from the outside cooling oil passage 53 into the first through-hole 24 of the A (or E) magnetic steel sheet 21. Then, the cooling oil further flows from the first through-hole 24 of the A (or E) magnetic steel sheet 21 into the through-hole 24 of the B magnetic steel sheet 21 by means of capillary action. Moreover, in the same manner, the cooling oil further flows through the through-holes 24 of the C and D magnetic steel sheets 21 and the second through-hole 24 of the E (or A) magnetic steel sheet 21. Finally, the cooling oil flows out of the second through-hole 24 of the E (or A) magnetic steel sheet 21 into the corresponding slot 23 of the stator core 2. More specifically, the cooling oil flows into the gap between the insulator 31 and those internal walls of the stator core 2 which define the corresponding slot 23. In addition, the dashed arrow lines in FIGS. 4-6 indicate the directions of the cooling oil flow through the through-holes 24 of the magnetic steel sheets 21.

In the present embodiment, the dimensions of each of the inside cooling oil passages 25 are set so as to allow the cooling oil to flow from the outside cooling oil passage 53 into the corresponding slot 23 of the stator core 2 via the inside cooling oil passage 25 by means of capillary action.

More specifically, in the present embodiment, the dimensions of each of the inside cooling oil passages 25 are set so as to satisfy the following inequality:

2×(a+t)×σ cos θ≧a×t×b×ρ×g (1),

where a represents the width (in m) of each of the through-holes 24 of the magnetic steel sheets 21 in the circumferential direction of the stator core 2,

t represents the thickness (in m) of each of the magnetic steel sheets 21 in the axial direction of the stator core 2,

σ represents the surface tension (in N/m) of the cooling oil,

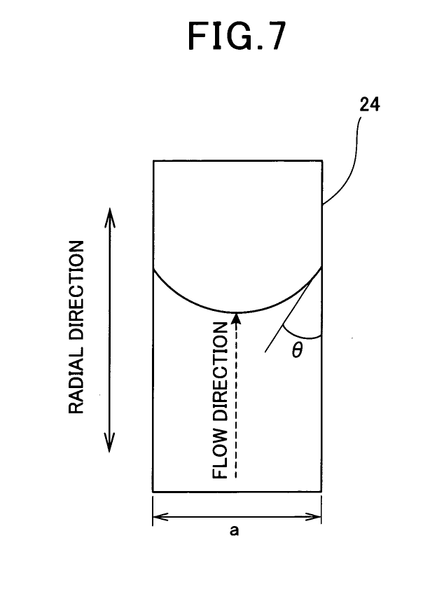

θ represents the contact angle (in °) between the cooling oil and those internal walls of the magnetic steel sheets 21 which define the through-holes 24 (see FIG. 7),

b represents the length (in m) of a back portion 28 of the stator core 2 (i.e., the length of each of the inside cooling oil passages 25 in the radial direction of the stator core 2),

ρ represents the density (in kg/m³) of the cooling oil, and

g represents the gravitational acceleration (in m/s²).

In addition, the left and right sides of the above inequality (1) respectively represent the driving force Fσ due to the surface tension of the cooling oil and the gravity Fg of the cooling oil.

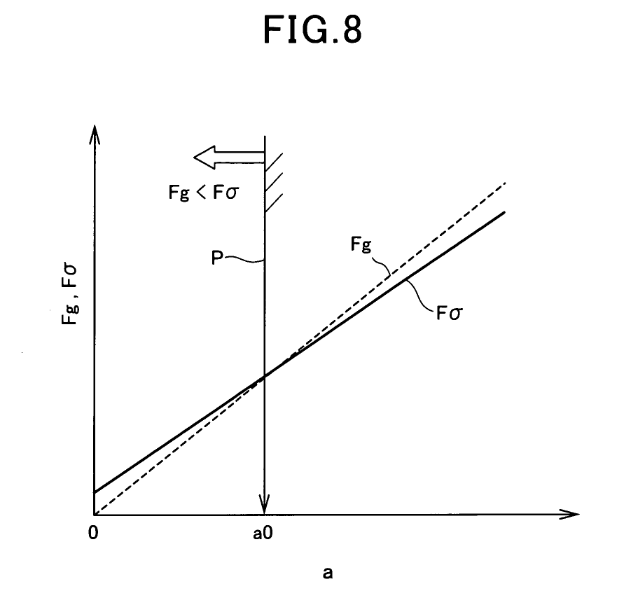

FIG. 8 illustrates the manner of setting the width a of each of the through-holes 24 of the magnetic steel sheets 21 according to the present embodiment.

Specifically, suppose that t=0.4 mm and b=14 mm. Then, in FIG. 8, the driving force Fσ exceeds the gravity Fg only on the left side of a boundary line P. That is, to satisfy the above inequality (1), it is necessary to set the width a to be less than or equal to a threshold value aₒ which corresponds to the boundary line P.

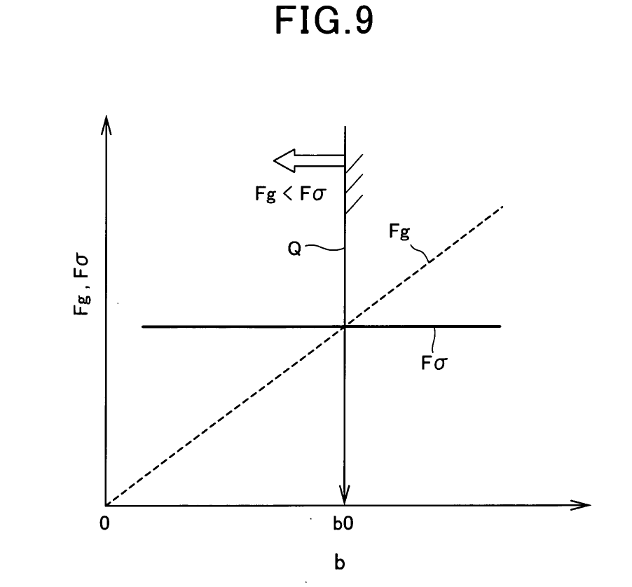

FIG. 9 illustrates the manner of setting the length b of each of the inside cooling oil passages 25 according to the present embodiment.

Specifically, suppose that a=5 mm and t=0.4 mm. Then, in FIG. 9, the driving force Fσ exceeds the gravity Fg only on the left side of a boundary line Q. That is, to satisfy the above inequality (1), it is necessary to set the length b to be less than or equal to a threshold value bₒ which corresponds to the boundary line Q.

After having described the overall configuration of the electric rotating machine 1 according to the present embodiment, the advantages thereof will be described hereinafter.

In the electric rotating machine 1, each of the magnetic steel sheets 21 forming the stator core 2 has the through-holes 24 that are formed to penetrate the magnetic steel sheet 21 in the axial direction of the stator core 2. All of the magnetic steel sheets 21 forming the stator core 2 are divided into a plurality of groups each of which includes five axially-adjacent magnetic steel sheets 21. For each of the groups, five corresponding through-holes 24 of the five magnetic steel sheets 21 of the group communicate with one another in the axial direction of the stator core 2, forming the inside cooling oil passage 25 that fluidically connects the outside coolant passage 53 with the corresponding slot 23 of the stator core 2.

With the above configuration, the cooling oil can flow from the outside cooling oil passage 53 into each of the slots 23 of the stator core 2 via the corresponding inside cooling oil passages 25. Consequently, the heat resistance between the stator core 2 and the stator coil 3 can be reduced, thereby more effectively transmitting the heat generated by the stator coil 3 to the stator core 2. As a result, it is possible to suppress the increase in the resistance of the stator coil 3 due to the heat generated by the stator coil 3, thereby ensuring high efficiency of the electric rotating machine 1. Moreover, it is also possible to prevent the insulating coat of the stator coil 3 from being damaged by the heat generated by the stator coil 3.

Furthermore, since the inside cooling oil passages 25 are formed without making the magnetic steel sheets 21 discontinuous in the circumferential direction, it is possible to ensure the strength of each of the magnetic steel sheets 21 and thus the strength of the entire stator core 2.

In the present embodiment, each of the through-holes 24 of the magnetic steel sheets 21 is formed so as to be radially aligned with a corresponding one of the slots 23 of the stator core 2.

With the above configuration, each of the inside cooling oil passages 25 is accordingly radially aligned with a corresponding one of the slots 23 of the stator core 2. Consequently, during the process of laminating the magnetic steel sheets 21 to form the stator core 2, it is unnecessary to circumferentially position the magnetic steel sheets 21 for placing each of the inside cooling oil passages 25 in fluid communication with a corresponding one of the slots 23 of the stator core 2. As a result, it is possible to simplify the laminating process, thereby lowering the manufacturing cost of the stator core 2.

In the present embodiment, the dimensions of each of the inside cooling oil passages 25 are set so as to allow the cooling oil to flow from the outside cooling oil passage 53 into the corresponding slot 23 of the stator core 2 via the inside cooling oil passage 25 by means of capillary action.

Setting the dimensions as above, it is possible to supply the cooling oil from the outside cooling oil passage 53 into each of the slots 23 of the stator core 2 without employing an additional supplying means. Moreover, since the amount of the cooling oil supplied into each of the slots 23 is regulated by the capillary action, it is possible to suppress leakage of the cooling oil from the slots 23 to the rotor 4. Consequently, it is possible to suppress accumulation of the cooling oil in the gap between the stator core 2 and the rotor 4, thereby minimizing torque loss due to the shearing resistance of the cooling oil.

Further, in the present embodiment, the dimensions of each of the inside cooling oil passages 25 are set so as to satisfy the above-described inequality (1); the left and right sides of the inequality (1) respectively represent the driving force Fσ due to the surface tension of the cooling oil and the gravity Fg of the cooling oil.

Setting the dimensions as above, it is possible to reliably supply, by means of capillary action, the cooling oil from the outside cooling oil passage 53 into each of the slots 23 of the stator core 2 regardless of the orientation of the electric rotating machine 1 in the motor vehicle.

### [First Comparative Example]

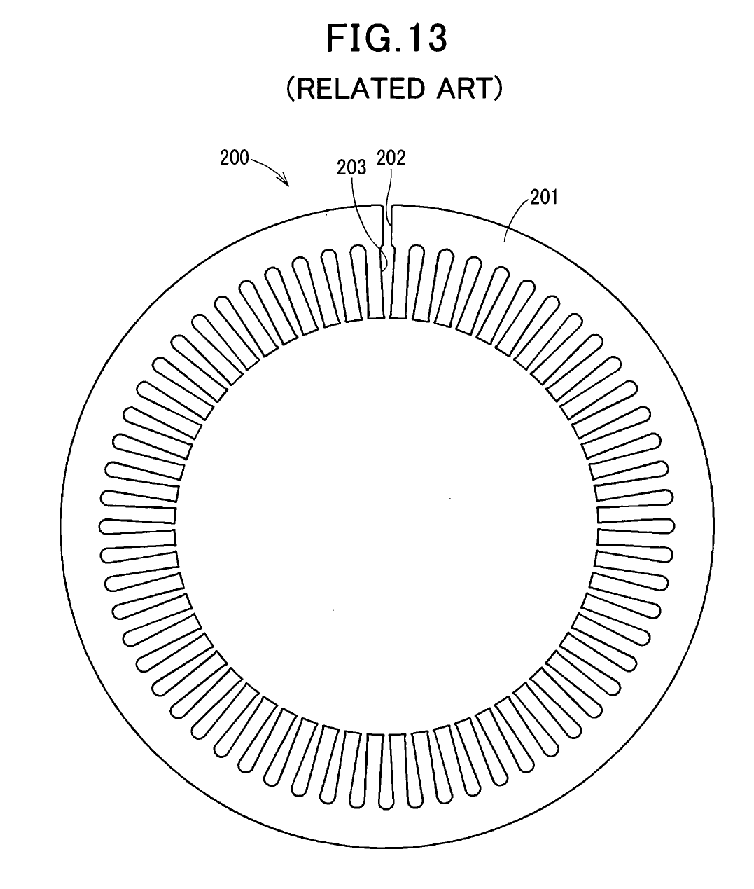

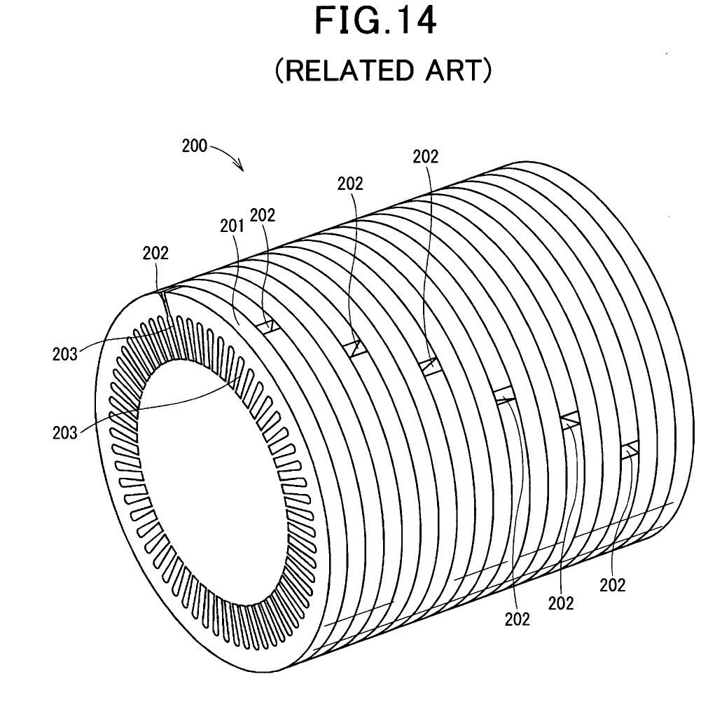

FIGS. 13 and 14 illustrate the configuration of a stator core 200 according to the previously-described first technique disclosed in Patent Document 1.

As shown in FIGS. 13 and 14, the stator core 200 has a plurality of cooling oil passages 202 formed therein. Each of the cooling oil passages 202 radially extends so as to fluidically connect one of the slots 203 of the stator core 200 to the radially outside of the stator core 200. Consequently, the cooling oil can be supplied from the radially outside of the stator core 200 into the slots 203 of the stator core 200 via the cooling oil passages 202.

However, with the above configuration, at least part of the magnetic steel sheets 201 forming the stator core 200 are made, by the corresponding cooling oil passages 202, to be discontinuous in the circumferential direction of the stator core 200. Consequently, the strength of each of the discontinuous magnetic steel sheets 201 and thus the strength of the entire stator core 200 may be considerably lowered.

Moreover, with the above configuration, for allowing each of the slots 203 to have one of the cooling oil passage 202 fluidically connected thereto, it is necessary to circumferentially position the magnetic steel sheets 201 during the process of laminating them. Consequently, the laminating process may become complicated, thereby increasing the manufacturing cost of the stator core 200.

### [Second Embodiment]

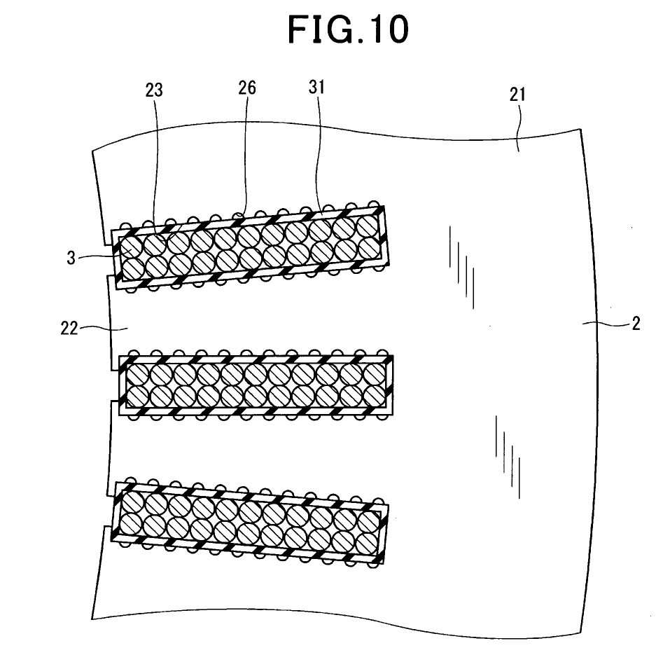

FIGS. 10-12 show the configuration of a stator according to the second embodiment of the invention.

In the present embodiment, as shown in FIGS. 10-12, in those internal walls of the magnetic steel sheets 21 which define the slots 23 of the stator core 2, there are formed grooves 26 that extend in the axial direction of the stator core 2.

Moreover, in the present embodiment, each of the grooves 26 has a substantially semicircular cross section perpendicular to the axial direction of the stator core 2. The magnetic steel sheets 21 also have rounded edge portions 27 that are respectively formed at axial ends of the internal walls of the magnetic steel sheets 21. Further, the radius r of the cross sections of the grooves 26 is set to be less than the radius R of the rounded edge portions 27 of the magnetic steel sheets 21.

In addition, the grooves 26 may be formed, for example by grinding, in the respective magnetic steel sheets 21 before laminating them. Otherwise, the grooves 26 may also be formed after laminating the magnetic steel sheets 21 together. In the latter case, the grooves 26 would be aligned with one another in the laminating direction of the magnetic steel sheets 21 (or in the axial direction of the stator core 2).

In operation, the cooling oil, which is introduced into the housing 5 through the cooling oil inlets 52 (see FIG. 1), drops on the coil ends 32 of the stator coil 3. Then, the cooling oil spreads along the surfaces of the coil ends 32 of the stator coil 3, flowing into the gaps between the internal walls of the magnetic steel sheets 21 (i.e., the stator core 2) and the insulator 31 and between the stator coil 3 and the insulator 31.

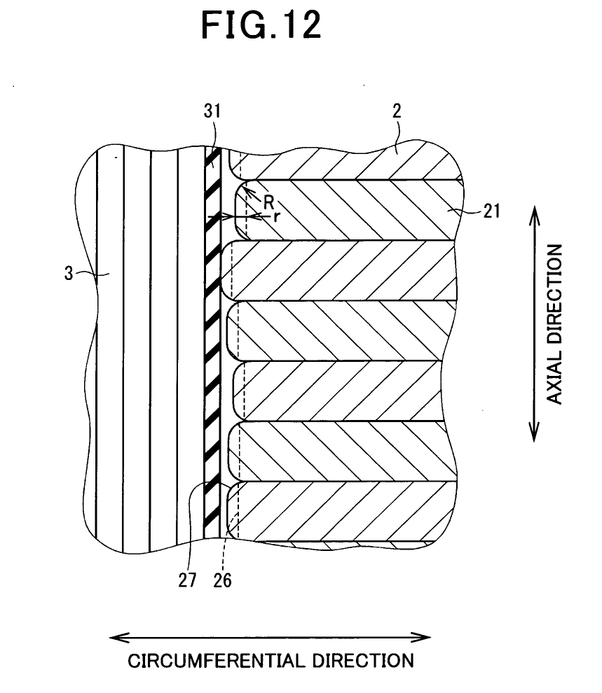

In the present embodiment, as described above, there are formed the grooves 26 in the internal walls of the magnetic steel sheets 21. Consequently, even if the insulator 31 is disposed in partial contact with the internal walls of the magnetic steel sheets 21 as shown in FIG. 12, it is still possible for the cooling oil to flow through the grooves 26 to occupy the entire axial length of each of the gaps between the insulator 31 and the internal walls of the magnetic steel sheets 21. As a result, the heat resistance between the stator core 2 and the stator coil 3 can be reduced, thereby more effectively transmitting the heat generated by the stator coil 3 to the stator core 2.

Further, as described above, the radius r of the cross sections of the grooves 26 is set to be less than the radius R of the rounded edge portions 27 of the magnetic steel sheets 21. Consequently, it is possible to reliably retain the cooling oil between the insulator 31 and the rounded edge portions 27 of the magnetic steel sheets 21.

In contrast, if the radius r of the cross sections of the grooves 26 was not less than the radius R of the rounded edge portions 27, the cooling oil would easily flow through the grooves 26, making it difficult to retain the cooling oil between the insulator 31 and the rounded edge portions 27.

### [Second Comparative Example]

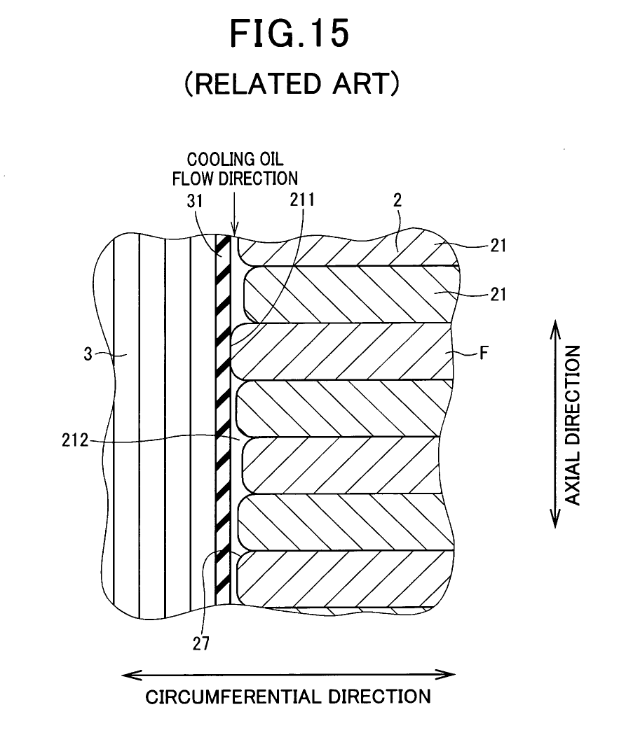

In this comparative example, as shown in FIG. 15, there are no grooves 26 formed in the internal wills of the magnetic steel sheets 21. Moreover, the insulator 31 is disposed to make contact with an F magnetic steel sheet 21 at a contact spot 211.

Consequently, the cooling oil, which flows into the gap between the insulator 31 and the internal walls of the magnetic steel sheets 21 from one axial side of the stator core 2, will be blocked at the contact spot 211. As a result, there will be formed an air layer 212 in the gap on the other axial side of the contact spot 211, thereby keeping high the heat resistance between the stator coil 3 and the stator core 2.

While the above particular embodiments of the present invention have been shown and described, it will be understood by those skilled in the art that various modifications, changes, and improvements may be made without departing from the spirit of the invention.

For example, in the previous embodiments, the electric rotating machine 1 is a brushless motor. However, the invention may also be applied to other types of electric motors and electric generators.

In the first embodiment, all of the magnetic steel sheets 21 forming the stator core 2 are divided into a plurality of groups each of which includes five axially-adjacent magnetic steel sheets 21; for each of the groups, five corresponding through-holes 24 of the magnetic steel sheets 21 of the group communicate with one another to form one inside cooling oil passage 25.

However, it is also possible that: each of the groups includes n axially-adjacent magnetic steel sheets 21; and for each of the groups, n corresponding through-holes 24 of the magnetic steel sheets 21 of the group communicate with one another to form one inside cooling oil passage 25, where n is an. integer not less than 2 and different from five.

In the second embodiment, the means for supplying the cooling oil to the coil ends 32 of the stator coil 3 is constituted by the cooling oil inlets 52. However, the electric rotating machine 1 may also have other means for supplying the cooling oil to the coil ends 32. For example, the electric rotating machine 1 may further include cooling oil pipes each of which is inserted into the housing 5 to have an open end thereof located in close vicinity to one of the coil ends 32 of the stator coil 3.

Furthermore, it is also possible to combine the configurations of the stators according to the first and second embodiments to form a stator which includes both the inside cooling oil passages 25 described in the first embodiment and the grooves 26 described in the second embodiment.

What is claimed is:

1. An electric rotating machine comprising:
a stator including a hollow cylindrical stator core and a stator coil mounted on the stator core, the stator core being formed by laminating a plurality of magnetic steel sheets and having a plurality of slots that are formed in a radially inner surface of the stator core and spaced in a circumferential direction of the stator core, the stator coil being partially received in the slots of the stator core to have a pair of coil ends that protrude outside the slots of the stator core respectively on opposite axial sides of the stator core;
a rotor that is rotatably disposed radially inside the stator core; and
a housing that receives both the rotor and the stator with a gap formed between an inner surface of the housing and a radially outer surface of the stator core, the gap making up an outside coolant passage in which a coolant is to flow,
wherein
each of the magnetic steel sheets forming the stator core has a plurality of through-holes that are formed to penetrate the magnetic steel sheet in an axial direction of the stator core,
all of the magnetic steel sheets forming the stator core are divided into a plurality of groups each of which includes axially-adjacent n of the magnetic steel sheets, where n is an integer not less than 2,
for each of the groups, corresponding n of the through-holes of the n magnetic steel sheets of the group communicate with one other to form an inside coolant passage that fluidically connects the outside coolant passage with a corresponding one of the slots of the stator core.

2. The electric rotating machine as set forth in claim 1, wherein each of the through-holes of the magnetic steel sheets is formed so as to be radially aligned with a corresponding one of the slots of the stator core.

3. The electric rotating machine as set forth in claim 1, wherein the dimensions of the inside coolant passage are set so as to allow the coolant to flow from the outside coolant passage into the corresponding slot via the inside coolant passage by means of capillary action.

4. The electric rotating machine as set forth in claim 3, wherein the dimensions of the inside coolant passage are set so as to satisfy the following relationship:
2×(a+t)×σ cos θ≧a×t×b×p×g, where a represents the width of each of the through-holes of the magnetic steel sheets in the circumferential direction of the stator core,
t represents the thickness of each of the magnetic steel sheets in the axial direction of the stator core,
σ represents the surface tension of the cooling oil,
θ represents a contact angle between the cooling oil and internal walls of the magnetic steel sheets which define the through-holes,
b represents the length of the inside coolant passage in a radial direction of the stator core,
p represents the density of the cooling oil, and
g represents the gravitational acceleration.

5. The electric rotating machine as set forth in claim 1, further comprising means for supplying the coolant to the coil ends of the stator coil, wherein in internal walls of the magnetic steel sheets which define the slots of the stator core, there are formed grooves that extend in the axial direction of the stator core.

6. The electric rotating machine as set forth in claim 5, wherein each of the grooves has a substantially semicircular cross section perpendicular to the axial direction of the stator core,
each of the magnetic steel sheets also has rounded edge portions that are respectively formed at axial ends of the internal walls of the magnetic steel sheet, and
the radius of the cross sections of the grooves is set to be less than the radius of the rounded edge portions of the magnetic steel sheets.

7. An electric rotating machine comprising:
a stator including a hollow cylindrical stator core and a stator coil mounted on the stator core, the stator core being formed by laminating a plurality of magnetic steel sheets and having a plurality of slots that are formed in a radially inner surface of the stator core and spaced in a circumferential direction of the stator core, the stator coil being partially received in the slots of the stator core to have a pair of coil ends that protrude outside the slots of the stator core respectively on opposite axial sides of the stator core;
a rotor that is rotatably disposed radially inside the stator core; and
means for supplying a coolant to the coil ends of the stator coil,
wherein
in internal walls of the magnetic steel sheets which define the slots of the stator core, there are formed grooves that extend in an axial direction of the stator core.

8. The electric rotating machine as set forth in claim 7, wherein each of the grooves has a substantially semicircular cross section perpendicular to the axial direction of the stator core,
each of the magnetic steel sheets also have rounded edge portions that are respectively formed at axial ends of the internal walls of the magnetic steel sheet, and
the radius of the cross sections of the grooves is set to be less than the radius of the rounded edge portions of the magnetic steel sheets.
